(19) United States
(12) Patent Application Publication
(10) Pub. No.: US 2019/0346841 A1
(43) Pub. Date: Nov. 14, 2019

(54) METHOD AND SYSTEM FOR REMOTELY GUIDING AN AUTONOMOUS VEHICLE

(71) Applicant: GM GLOBAL TECHNOLOGY OPERATIONS LLC, Detroit, MI (US)

(72) Inventors: Bakhtiar B. Litkouhi, Washington, MI (US); Fan Bai, Ann Arbor, MI (US)

(21) Appl. No.: 15/974,999

(22) Filed: May 9, 2018

(51) Int. Cl. G05D 1/00; G05D 1/02; H04W 76/10; H04W 24/08

(52) U.S. Cl. CPC G05D 1/0022; G05D 1/0038; G05D 1/0246; H04L 43/0829; H04W 76/10; H04W 24/08; G05D 1/0257

(57) ABSTRACT

A system and method for remotely guiding an autonomous vehicle. The method includes receiving, by a controller of the autonomous vehicle, captured information relating to a scene. Controlling the autonomous vehicle through the scene requires input from a remote operator. The method also includes prioritizing the captured information. The method also includes transmitting the captured information to the remote operator based on the prioritizing. Higher priority information is transmitted to the remote operator.

### INTRODUCTION

The subject embodiments relate to remotely guiding an autonomous vehicle. Specifically, one or more embodiments can be directed to enabling a remote operator to guide the autonomous vehicle. One or more embodiments can also identify which information is necessary to be provided to the remote operator in order for the operator to control the autonomous vehicle, for example.

An autonomous vehicle is generally considered to be a vehicle that is able to navigate through an environment without being directly guided by a human driver. The autonomous vehicle can use different methods to sense different aspects of the environment. For example, the autonomous vehicle can use global positioning system (GPS) technology, radar technology, laser technology, and/or camera/imaging technology to detect the road, other vehicles, and road obstacles.

### SUMMARY

In one exemplary embodiment, a method includes receiving, by a controller of an autonomous vehicle, captured information relating to a scene. Controlling the autonomous vehicle through the scene requires input from a remote operator. The method also includes prioritizing the captured information. The method also includes transmitting the captured information to the remote operator based on the prioritizing. Higher priority information is transmitted to the remote operator.

In another exemplary embodiment, the captured information includes camera information and/or lidar information and/or radar information and/or other advanced perception sensor information.

In another exemplary embodiment, the prioritizing the captured information includes prioritizing based on at least one of: (1) a location relevance of a device that captured the information, (2) a resolution of the information, and (3) a confidence associated with the information. A location relevance of a device is based on whether the device's location allows the device to capture information that is useful to the remote operator.

In another exemplary embodiment, the method also includes establishing a communication channel between the autonomous vehicle and the remote operator. The method also includes determining a quality of the communication channel.

In another exemplary embodiment, the quality of the communication channel is determined based on a packet-drop ratio of the communication channel, a determined delay for the communication channel, and/or a determined jitter for the communication channel.

In another exemplary embodiment, the higher priority information is determined based on the determined quality of the communication channel.

In another exemplary embodiment, the communication channel is established between the autonomous vehicle, a base station, and the remote operator.

In another exemplary embodiment, the method also includes receiving a request for additional information from the remote operator. The method also includes transmitting additional information to the remote operator based on the request.

In another exemplary embodiment, the additional information includes information of higher resolution and/or information that was not previously transmitted to the operator.

In another exemplary embodiment, the method also includes receiving control input from the remote operator. The autonomous vehicle is controlled through the scene based on the received control input.

In another exemplary embodiment, a system within an autonomous vehicle includes an electronic controller of the vehicle configured to receive captured information relating to a scene. Controlling the autonomous vehicle through the scene requires input from a remote operator. The electronic controller is also configured to prioritize the captured information. The electronic controller is also configured to transmit the captured information to the remote operator based on the prioritizing. Higher priority information is transmitted to the remote operator.

In another exemplary embodiment, the captured information includes camera information and/or lidar information and/or radar information and/or other advanced perception sensor information.

In another exemplary embodiment, the prioritizing the captured information includes prioritizing based on at least one of: (1) a location relevance of a device that captured the information, (2) a resolution of the information, and (3) a confidence associated with the information. A location relevance of a device is based on whether the device's location allows the device to capture information that is useful to the remote operator.

In another exemplary embodiment, the electronic controller is further configured to establish a communication channel between the autonomous vehicle and the remote operator. The electronic controller is also configured to determine a quality of the communication channel.

In another exemplary embodiment, the quality of the communication channel is determined based on a packet-drop ratio of the communication channel, a determined delay for the communication channel, and/or a determined jitter for the communication channel.

In another exemplary embodiment, the higher priority information is determined based on the determined quality of the communication channel.

In another exemplary embodiment, the communication channel is established between the autonomous vehicle, a base station, and the remote operator.

In another exemplary embodiment, the electronic controller is further configured to receive a request for additional information from the remote operator. The electronic controller is also configured to transmit additional information to the remote operator based on the request.

In another exemplary embodiment, the additional information includes information of higher resolution and/or information that was not previously transmitted to the operator.

In another exemplary embodiment, the electronic controller is further configured to receive control input from the remote operator. The autonomous vehicle is controlled through the scene based on the received control input.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an example camera/sensor configuration for an autonomous vehicle in accordance with one or more embodiments;

FIG. 2 illustrates example coverage areas that are covered by an example sensor/camera configuration in accordance with one or more embodiments;

FIG. 3 illustrates an example process for enabling a remote operator to remotely guide an autonomous vehicle in accordance with one or more embodiments;

FIG. 4 illustrates a process of transmitting communication between a remote operator and an autonomous vehicle in accordance with one or more embodiments;

FIG. 5 illustrates managing links of communication between a remote operator and an autonomous vehicle in accordance with one or more embodiments;

FIG. 6 depicts a flowchart of a method in accordance with one or more embodiments of the invention; and

FIG. 7 depicts a high-level block diagram of a computer system, which can be used to implement one or more embodiments of the invention.

### DETAILED DESCRIPTION

The following description is merely exemplary in nature and is not intended to limit the present disclosure, its application or uses. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As described above, one or more embodiments are directed to remotely guiding an autonomous vehicle. Specifically, one or more embodiments can be directed to enabling a remote operator to guide the autonomous vehicle. One or more embodiments can identify when a remote operator needs to initiate remote control over the autonomous vehicle. One or more embodiments also determine which types of information are needed by the remote operator to properly guide the autonomous vehicle. One or more embodiments can also be directed to a method of establishing a communication channel to facilitate communication between the remote operator and the autonomous vehicle. One or more embodiments can also determine the conditions of the communication channel, and one or more embodiments can determine which information is necessary to be transmitted to the remote operator based on the determined conditions of the communication channel.

One or more embodiments of the invention can automatically monitor fluctuations in a quality of communication that is transmitted via the communication channel, and one or more embodiments can adjust the type of communication that is transferred between the autonomous vehicle and the remote operator based on the monitored fluctuations.

As an autonomous vehicle travels through a scene, the autonomous vehicle can encounter certain atypical driving scenarios that are difficult for the vehicle to autonomously travel through. An atypical driving scenario can correspond to any driving scenario that is not normally encountered by the autonomous vehicle. Specifically, an atypical scenario can be a driving scenario that requires the autonomous vehicle to be controlled in manner that is different from the autonomous vehicle's normally-configured behavior. For example, the autonomous vehicle can encounter a police officer that is guiding the traffic along a driving path that would normally be an illegal driving path. When encountering such atypical driving scenarios, the autonomous vehicle can initiate a request for a remote operator to take over control of the vehicle. After control over the vehicle is granted to a remote operator, one or more embodiments of the invention can also identify the information that is needed to be transmitted to the remote operator in order to enable the remote operator to properly control the vehicle.

A vehicle of one or more embodiments can transmit information that is captured by sensors/cameras to the remote operator. Additionally, the vehicle can provide the remote operator with information relating to the vehicle's immediate as well as its final destinations, information relating to a map of the relevant area, information relating to a road topology of the relevant area, live imagery/video of the surrounding area, audio information, and/or a travel history of the vehicle, for example. Upon receiving the information from the vehicle, the remote operator can remotely examine the situation and can control the vehicle accordingly. The remote operator can control the vehicle's behavior and motion by transmitting input commands to the vehicle.

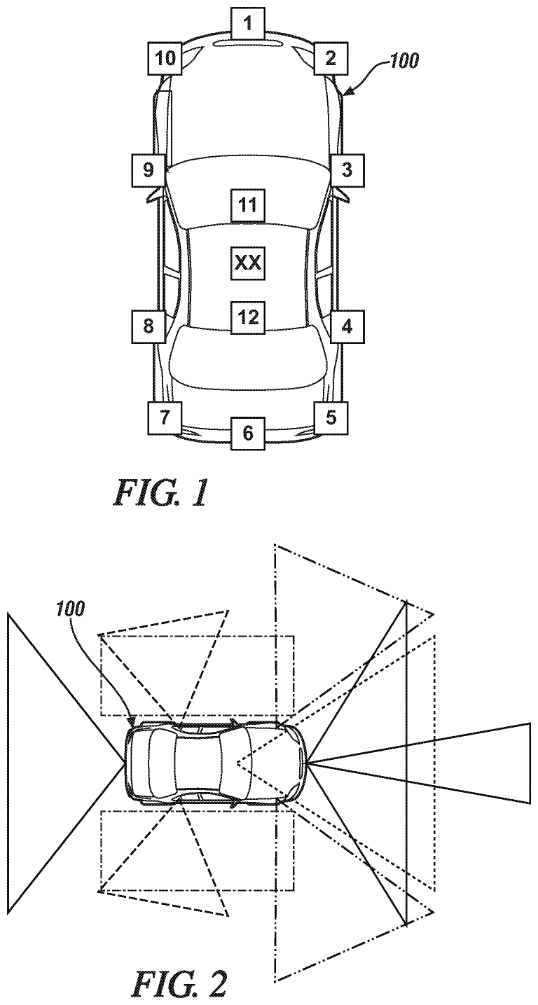

FIG. 1 illustrates an example camera/sensor configuration for an autonomous vehicle 100 in accordance with one or more embodiments. In the example of FIG. 1, autonomous vehicle 100 includes at least 12 different camera/sensing devices 1-12 in the form of cameras, LIDAR devices, and/or radars. Other example embodiments can include more or fewer devices. The devices are positioned at different positions on the vehicle 100, and each device can provide a type of information relating to the scene. Each device can capture information from a particular perspective/angle relative to the vehicle 100. Depending on the positioning/location of each device, the devices can provide information of different relevance to the remote operator. If a device is positioned in a manner that captures the relevant information of a scene for the remote operator, the device can be considered to have high location relevance. As described in further detail below, the relevance of information can also be based on other factors such as, but not limited to, a resolution of the information and the type of information.

FIG. 2 illustrates example coverage areas that are covered by an example camera/sensor configuration in accordance with one or more embodiments. Each camera/sensing device of the example autonomous vehicle 100 can provide data from a particular perspective. The different devices can provide different types of information (video information, radar information, image information, etc.) as well. Each device can sense/capture information relating to surrounding objects within a certain coverage area.

As described above, when autonomous vehicle 100 encounters an atypical driving situation, certain camera/sensor devices can be configured to provide information that is more relevant/useful to the remote operator as compared to the information that is provided by other devices. For example, certain camera/sensor devices can be positioned closer to the atypical driving situation and thus these closely-positioned devices can provide information that is more relevant compared to the information that is provided by other devices that are positioned further away from the atypical driving situation. As described in more detail below, when transmitting information to the remote operator, the information typically needs to be transmitted very quickly on limited resources. Therefore, in view of the need to transmit information quickly to the remote operator by using limited resources, there is a need to determine which information is more relevant/useful to the remote operator and to place higher priority on transmitting such relevant/useful information. As described in more detail below, one or more embodiments are directed to a system that determines which information (that is captured by the camera/sensor devices) is more relevant/useful to the remote operator, and one or more embodiments can prioritize transmitting such relevant/useful information over the transmission of other information that is captured by the camera/sensor devices.

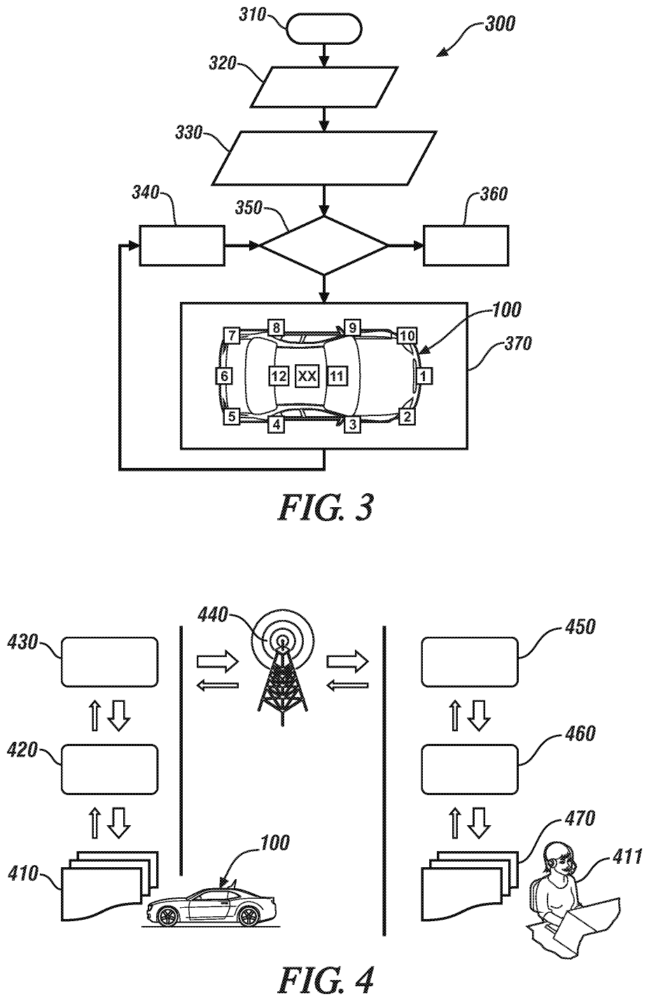

FIG. 3 illustrates an example process 300 for enabling a remote operator to remotely guide an autonomous vehicle in accordance with one or more embodiments. At 310, the process for enabling the remote operator to remotely guide the vehicle begins. At 320, the autonomous vehicle can establish a communication channel with the remote operator. As described later in greater detail, the communication channel can be a bi-directional channel that allows the autonomous vehicle to transmit captured/sensed information to the remote operator, and the communication channel also allows the remote operator to transmit control instructions to the vehicle. As described in more detail herein, one or more embodiments can determine the quality of communication that is capable of being transmitted on the communication channel. Specifically, one or more embodiments can determine whether communication resources (such as bandwidth, for example) is limited. At 330, the autonomous vehicle can identify the available camera/sensor devices and the locations of the available devices to the remote operator. One or more embodiments can also determine which information that is captured by the devices is more useful/relevant to the remote operator, and this useful/relevant information can be given higher priority when transferring communication to the remote operator. The relevant information can include, but is not limited to, for example, navigation map information, information relating to the current path of the vehicle, visual information relating to the environment, and/or any other information relating to the driving scenario. At 350, the autonomous vehicle can determine whether the encountered driving scenario is an atypical driving scenario that will need control/intervention by the remote operator. At 360, if the driving scenario is determined to be normal (i.e., the driving scenario is determined to be typical), then the process communicates to the vehicle that the vehicle can operate in accordance with its typical autonomous procedures.

At 350, if the driving scenario is determined to not be normal (i.e., the driving scenario is determined to be atypical), then the operator can request information from the vehicle 100. For example, at 370, the operator can request additional information from certain specific devices by choosing specific points on the vehicle that correspond to different devices. In one example embodiment, the operator can access a user interface to click on the specific camera/sensory devices that the operator wants to receive information from. After the useful/information is received from the selected camera/sensory device, the operator can then further click on the selected device, where each subsequent click can increase the resolution of the information that the device provides to the operator, for example. Therefore, if the operator requires additional or more detailed information than the information that was previously determined to be useful/relevant by one or more embodiments, then the operator can specifically indicate which additional information to receive and how detailed the information needs to be at 340.

FIG. 4 illustrates a process of transmitting communication between a remote operator and an autonomous vehicle in accordance with one or more embodiments. At 410, autonomous vehicle 100 can transmit vehicle camera and/or sensor information toward the remote operator 411. At 420, an information prioritization module of vehicle 100 determines which device information is more useful/relevant to the remote operator 411 in view of the available communication resources. After prioritizing the captured camera/sensor information, the information prioritization module 420 transmits the information toward remote operator 411. As described in more detail herein, vehicle 100 can transmit device information based on a determined communication channel condition. For example, if vehicle 100 determines that the quality-of-service metrics of the communication channel indicate that communication resources are limited, then the information prioritization module can prioritize the communication of higher priority information over the communication of lower priority information. However, if the communication channel has sufficient capacity, all relevant information may be transmitted from the vehicle to the remote operator. At 430, a virtual machine offloading client of vehicle 100 can transmit the relevant device information to a base station 440. Base station 440 can transmit the relevant device information towards remote operator 411. At 450, a system of the remote operator 411 can receive the device information from the base station 440. For example, an offloading server of the remote operator's system receives the relevant device information. At 460, an information reconstruction module of the system assembles the relevant device information. The captured information can be captured from disparate sources, and the captured information can be combined to provide the remote operator with a more comprehensive view of the scene. In one or more embodiments, the information reconstruction module of the system can present the device information within a user interface that is accessible by the remote operator 411. At 470, the system of the remote operator can perform replication of the information that is captured by the vehicle devices. The remote operator 411 can review and operate the vehicle 100. For example, the remote operator 411 can transmit an input command toward autonomous vehicle 100.

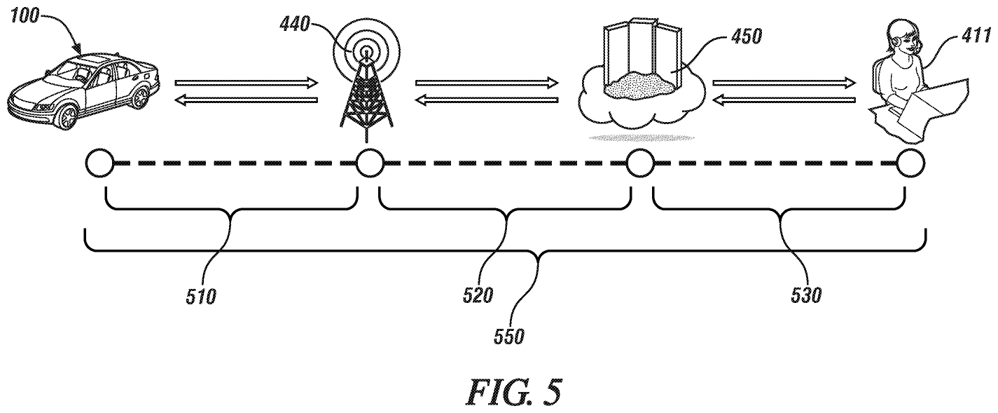

FIG. 5 illustrates managing links of communication between a remote operator and an autonomous vehicle in accordance with one or more embodiments. In the example of FIG. 5, three communication links 510, 520 and 530 are configured between autonomous vehicle 100, base station 440, offloading server 450, and remote operator 411. Specifically, link 510 is configured between autonomous vehicle 100 and base station 440, link 520 is configured between base station 440 and offloading server 450, and link 530 is configured between offloading server 450 and remote operator 411. A path 550 between the autonomous vehicle 100 and the remote operator 411 is formed by the plurality of links 510-530. Autonomous vehicle 100 can transmit captured/sensed data to remote operator 411 via path 550. Remote operator 411 can transmit control input commands to control autonomous vehicle 100 via path 550.

As described, one or more embodiments can monitor the quality of communication that can be transmitted on an established communication channel between the autonomous vehicle 100 and the remote operator 411. One or more embodiments can also determine whether one or more communication resources are limited. Referring to FIG. 5, one or more embodiments can monitor the quality of each communication link of path 550. Specifically, one or more embodiments can measure different quality-of-service (QoS) metrics relating to each communication link in real-time. Based on the QoS metrics relating to each communication link, one or more embodiments can determine a condition of the communication channel. As described in further detail below, if the QoS metrics provide an indication that communication resources are limited, then one or more embodiments can decide to transmit higher priority information over lower priority information. One or more embodiments can determine which information is higher priority based on the condition of the communication channel. One or more embodiments can use different thresholds for each type of QoS metric when determining whether communication resources are limited.

One example metric for measuring the QoS for each link is a packet drop ratio for the link. The packet drop ratio reflects an amount of packets that are unsuccessfully transmitted via each link. The packet drop ratio for the link can be calculated as follows:

\tilde{P}(t)=α×P(t)+(1−α)\tilde{P}(t−1)

Where P(t) corresponds to a measured ratio of packets that have been dropped at time t, and where α corresponds to a weighting factor. It should be understood that the above mathematical formulation is only one such example, among many other alternative formulations to define the packet drop ration.

Another example metric for measuring the QoS for each link is a delay for the link. A delay for a link can be calculated as follows:

\tilde{τ}(t)=α×τ(t)+(1−α)×\tilde{τ}(t−1)

Where τ(t) corresponds to a measured delay that has occurred at time t for the link, and where α corresponds to a weighting factor. It should be understood that the above mathematical formulation is only one such example, among many other alternative formulations to define the link delay.

Another example metric for measuring the QoS for each link is a jitter for the link. A jitter for a link can be calculated as follows:

\tilde{σ}(t)=α×σ(t)+(1−α)×\tilde{σ}(t−1)

Where σ(t) corresponds to a measured jitter that has occurred at time t for the link, and where α corresponds to a weighting factor. It should be understood that the above mathematical formulation is only one such example, among many other alternative formulations to define the link jitter.

Another example metric for measuring the QoS for each link is a throughput. A throughput for the link can be calculated as follows:

\tilde{T}(t)=α×T(t)+(1−α)×\tilde{T}(t−1)

Where T(t) corresponds to a measured throughput that has occurred at time t for the link, and where α corresponds to a weighting factor. It should be understood that the above mathematical formulation is only one such example, among many other alternative formulations to define the throughput of a wireless connection link.

Upon determining QoS metrics for each of links 510-530, one or more embodiments can determine path-level QoS metrics for path 550. With regard to path-level network status monitoring, the path-level QoS metrics for a particular path can be determined based on the link-level QoS metrics of the links which form the particular path. In other words, the path-level QoS metrics for path 550 can be determined based on the link-level QoS metrics of links 510-530 (where links 510-530 form path 550).
One example path-level QoS metric can be a packet drop ratio for path 550. The path-level packet drop ratio can be calculated as follows:

$${P}_{Path} ( t ) = {\prod }_{i} {P}_{link}^{i} ( t )$$

Another example path-level QoS metric can be a delay for path 550. The path-level delay can be calculated as follows:

$${τ}_{Path} ( t ) = {\sum }_{i} {τ}_{link}^{i} ( t )$$

Another example path-level QoS metric can be a jitter for path 550. The path-level jitter can be calculated as follows:

$${σ}_{Path} ( t ) = {max}_{i} ( {σ}_{link}^{i} ( t ) )$$

Another example path-level QoS metric can be a throughput for path 550. The path-level throughput can be calculated as follows:

$${T}_{Path} ( t ) = {min}_{i} ( {T}_{link}^{i} ( t ) )$$

In view of the above, based on the QoS metrics relating to a path, one or more embodiments can determine a condition of the communication channel. As described in further detail herein, if the QoS metrics provide an indication that communication resources are limited, then one or more embodiments can transmit higher priority information over lower priority information. One or more embodiments can also use the OoS metrics to determine which information is to be considered as the high priority information. With one or more embodiments, if communication resources are severely limited, then one or more embodiments will be more restrictive when determining which information qualifies as high priority information. One or more embodiments can use different thresholds for each type of QoS metric when determining whether communication resources are limited. When a QoS of the communication indicates that there are limited channel resources available, one or more embodiments can strategically prioritize transmitting certain captured information over transmitting other captured information using a global scheduling algorithm, or a distributed scheduling algorithm.

One or more embodiments can determine which captured information is most relevant/useful to the remote operator based on considering different dimensions. Transmission of this relevant/useful captured information can then be prioritized over the transmission of information of lower relevance/usefulness. Therefore, one or more embodiments enable the remote operator to quickly receive relevant/useful information even if system/channel resources become scarce and/or limited (i.e., when a cellular bandwidth and/or a storage amount becomes scarce).

One or more embodiments can determine which captured information is most relevant/useful based on example considered dimensions including, but not limited to, the following: (1) a location relevance of sensors and/or cameras, (2) a sensor/camera resolution/confidence, and/or (3) inherent properties of the sensors/cameras. As described in further detail below, a utility function can take into account the different example considered dimensions when determining which information is most relevant/useful. Information that is associated with a higher calculated utility value can be considered to be information of higher priority.

Specifically, a utility function that takes into account the example dimension relating to (1) a location relevance of sensors and/or cameras can be expressed as follows:

U(dᵢ)=βe^{-αd}^{ᵢ}

Where an autonomous vehicle detects a plurality of objects i (i=0, . . . , n) at time t, and where the respective distance of each object to the autonomous vehicle is dᵢ (i=0, . . . , n). Each of the detected objects i (i=0, . . . , n) can be ranked based on each of their calculated respective utility function values. One or more embodiments can then upload an object list to the remote operator, where each object is ranked according to the above-described utility function. With one or more embodiments, if bandwidth is determined to be limited, the information relating to the lower-ranked objects will not be transmitted to the remote operator.

Next, with regard to the example dimension relating to (2) a sensor/camera resolution/confidence, an autonomous vehicle can have multiple devices (i.e., a camera device, a light detection and ranging (LIDAR) device, a sensor device, and/or a radar device) that each can provide data at different levels of confidence and resolution. For a particular sensor “j” using resolution level “k,” one or more embodiments can assign a weight, W_{j,k}, to reflect a level of trust of using this sensor “j” at a resolution level “k.”

As such, a utility function that takes into account both the example dimension relating to (1) a location relevance of sensors and/or cameras, and the example dimension relating to (2) a sensor/camera resolution/confidence, can be expressed as follows:

U_{j,k}(dᵢ)=βe^{-αd}^{ᵢ}W_{j,k}

As described above, each of the detected objects i (i=0, . . . , n) can be ranked based on each of their calculated respective utility function values. One or more embodiments can upload an object list to the remote operator, where each object is ranked according to the above-described utility function. With one or more embodiments, if bandwidth is determined to be limited, the information relating to the lower-ranked objects will not be transmitted to the remote operator. The object list can thus be transmitted to the remote operator based on the sensor resolution/confidence.

Next, with regard to the example dimension relating to (3) inherent properties of sensors/cameras, as described in further detail below, each video frame that is captured by a camera can have a different importance level in describing the scene. For example, with videos that use the Moving Pictures Expert Group (MPEG) standard or other advanced video coding standard such as H.26x standard family, a captured frame that is an intraframe (I-Frame) can be considered to be a frame of higher importance. On the other hand, bi-directional frames (B-frames) and predictive frames (P-frames) can be considered to be frames of lesser importance. As such, with regard to the example dimension relating to (3) the inherent properties of the sensors/cameras, a captured frame corresponding to an I-frame can be assigned a higher priority, while a captured frame corresponding to B-frames and P-frames can be assigned a lower priority.

A utility function that considers all three of the above-described example dimensions relating to (1) a location relevance of sensors and/or cameras, (2) a sensor/camera resolution/confidence, and (3) the inherent properties of the sensors/cameras, can be expressed as follows:

U_{j,k}(dᵢ)=βe^{-αd}^{ᵢ}W_{j,k}W_{I,B,P}

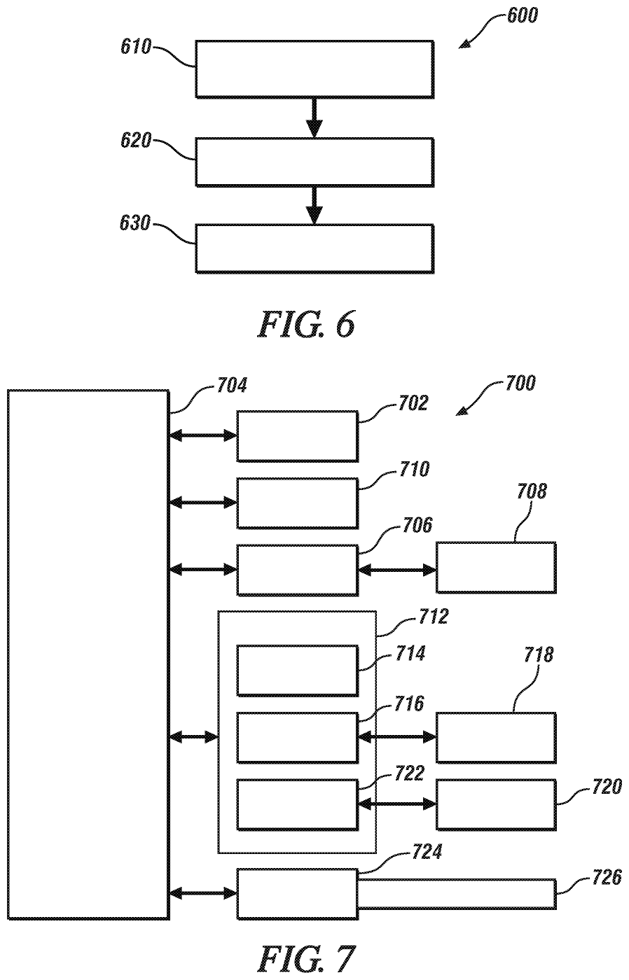

FIG. 6 depicts a flowchart of a method 600 in accordance with one or more embodiments. The method of FIG. 6 can be performed in order to remotely guide an autonomous vehicle and can be performed by a controller in conjunction with one or more vehicle sensors and/or camera devices. The controller can be implemented within an electronic control unit (ECU) of a vehicle, for example. The method of FIG. 6 can be performed by a vehicle controller that receives and processes imagery of a scene in which a vehicle is driven. The method can include, at block 610, receiving, by a controller of an autonomous vehicle, captured information relating to a scene. Controlling the autonomous vehicle through the scene requires input from a remote operator. The method can also include, at block 620, prioritizing the captured information. The method can also include, at block 630, transmitting the captured information to the remote operator based on the prioritizing. Higher priority information is transmitted to the remote operator.

FIG. 7 depicts a high-level block diagram of a computing system 700, which can be used to implement one or more embodiments. Computing system 700 can correspond to, at least, a system that is configured to initiate remote control over an autonomous vehicle, for example. The system can be a part of a system of electronics within a vehicle that operates in conjunction with a camera and/or a sensor. In one or more embodiments, computing system 700 can correspond to an electronic control unit (ECU) of a vehicle. Computing system 700 can be used to implement hardware components of systems capable of performing methods described herein. Although one exemplary computing system 700 is shown, computing system 700 includes a communication path 726, which connects computing system 700 to additional systems (not depicted). Computing system 700 and additional systems are in communication via communication path 726 (e.g., to communicate data between them).

Computing system 700 includes one or more processors, such as processor 702. Processor 702 is connected to a communication infrastructure 704 (e.g., a communications bus, cross-over bar, or network). Computing system 700 can include a display interface 706 that forwards graphics, textual content, and other data from communication infrastructure 704 (or from a frame buffer not shown) for display on a display unit 708. Computing system 700 also includes a main memory 710, preferably random access memory (RAM), and can also include a secondary memory 712. There also can be one or more disk drives 714 contained within secondary memory 712. Removable storage drive 716 reads from and/or writes to a removable storage unit 718. As will be appreciated, removable storage unit 718 includes a computer-readable medium having stored therein computer software and/or data.

In alternative embodiments, secondary memory 712 can include other similar means for allowing computer programs or other instructions to be loaded into the computing system. Such means can include, for example, a removable storage unit 720 and an interface 722.

In the present description, the terms “computer program medium,” “computer usable medium,” and “computer-readable medium” are used to refer to media such as main memory 710 and secondary memory 712, removable storage drive 716, and a disk installed in disk drive 714. Computer programs (also called computer control logic) are stored in main memory 710 and/or secondary memory 712. Computer programs also can be received via communications interface 724. Such computer programs, when run, enable the computing system to perform the features discussed herein. In particular, the computer programs, when run, enable processor 702 to perform the features of the computing system. Accordingly, such computer programs represent controllers of the computing system. Thus it can be seen from the forgoing detailed description that one or more embodiments provide technical benefits and advantages.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the embodiments not be limited to the particular embodiments disclosed, but will include all embodiments falling within the scope of the application.

What is claimed is:

1. A method, the method comprising:
receiving, by a controller of an autonomous vehicle, captured information relating to a scene, wherein controlling the autonomous vehicle through the scene requires input from a remote operator;
prioritizing the captured information; and
transmitting the captured information to the remote operator based on the prioritizing.

2. The method of claim 1, wherein the captured information comprises camera information and/or lidar information and/or radar information and/or other advanced perception information.

3. The method of claim 1, wherein the prioritizing the captured information comprises prioritizing based on at least one of: (1) a location relevance of a device that captured the information, (2) a resolution of the information, and (3) a confidence associated with the information, and a location relevance of a device is based on whether the device's location allows the device to capture information that is useful to the remote operator.

4. The method of claim 1, further comprising establishing a communication channel between the autonomous vehicle and the remote operator, and determining a quality of the communication channel.

5. The method of claim 4, wherein the quality of the communication channel is determined based on a packet-drop ratio of the communication channel, a determined delay for the communication channel, a determined jitter for the communication channel and/or a determined effective throughput for the communication channel.

6. The method of claim 4, wherein the higher priority information is determined based on the determined quality of the communication channel.

7. The method of claim 4, wherein the communication channel is established between the autonomous vehicle, a base station, and the remote operator.

8. The method of claim 1, further comprising receiving a request for additional information from the remote operator, and transmitting additional information to the remote operator based on the request.

9. The method of claim 8, wherein the additional information comprises information of higher resolution and/or information that was not previously transmitted to the operator.

10. The method of claim 1, further comprising receiving control input from the remote operator, wherein the autonomous vehicle is controlled through the scene based on the received control input.

11. A system within an autonomous vehicle, comprising:
an electronic controller of the vehicle configured to:
receive captured information relating to a scene, wherein controlling the autonomous vehicle through the scene requires input from a remote operator;
prioritize the captured information; and
transmit the captured information to the remote operator based on the prioritizing.

12. The system of claim 11, wherein the captured information comprises camera information and/or lidar information and/or radar information and/or other advanced perception information.

13. The system of claim 11, wherein the prioritizing the captured information comprises prioritizing based on at least one of: (1) a location relevance of a device that captured the information, (2) a resolution of the information, and (3) a confidence associated with the information, and a location relevance of a device is based on whether the device's location allows the device to capture information that is useful to the remote operator.

14. The system of claim 11, wherein the electronic controller is further configured to establish a communication channel between the autonomous vehicle and the remote operator, and determine a quality of the communication channel.

15. The system of claim 14, wherein the quality of the communication channel is determined based on a packet-drop ratio of the communication channel, a determined delay for the communication channel, a determined jitter for the communication channel and/or a determined effective throughput for the communication channel.

16. The system of claim 14, wherein the higher priority information is determined based on the determined quality of the communication channel.

17. The system of claim 14, wherein the communication channel is established between the autonomous vehicle, a base station, and the remote operator.

18. The system of claim 11, wherein the electronic controller is further configured to receive a request for additional information from the remote operator, and the electronic controller is further configured to transmit additional information to the remote operator based on the request.

19. The system of claim 18, wherein the additional information comprises information of higher resolution and/or information that was not previously transmitted to the operator.

20. The system of claim 11, wherein the electronic controller is further configured to receive control input from the remote operator, wherein the autonomous vehicle is controlled through the scene based on the received control input.
